(19) United States
(12) Patent Application Publication
(10) Pub. No.: US 2026/0157260 A1
(43) Pub. Date: Jun. 11, 2026

(54) AUTOMATIC WEAR DETECTION FOR ROW CROP PLANTER TOOLS

(71) Applicant: Deere & Company, Moline, IL (US)

(72) Inventors: Kevin J. Goering, Cambridge, IA (US); John P. Just, Ames, IA (US); Matthew M. Orth, Johnston, IA (US); Derek Nord, Bondurant, IA (US); Jason R. Whitler, Green Bay, WI (US)

(21) Appl. No.: 18/969,405

(22) Filed: Dec. 5, 2024

(51) Int. Cl. A01B 79/00; A01C 5/06; G01B 21/18; G06T 7/00

(52) U.S. Cl. CPC A01B 79/00; A01C 5/064; G01B 21/18; G06T 7/0002; G06T 2200/24; G06T 2207/20081

(57) ABSTRACT

A computer-implemented method is provided for real-time estimation of wear for a furrow-generating tool associated with an agricultural work machine. In a model development stage, input data sets are generated based on signals received from sensors for various agricultural work machines and planting operations, corresponding at least to values for furrow characteristics (e.g., depth, residue profile) and operating conditions (speed, down force), wherein learning models are trained correlating the input data sets with tool wear. In a current operation stage, values are determined for one or more furrow characteristics and one or more operating conditions based on received input signals from multiple work machine sensors, a current tool wear state is estimated based on the determined values and by reference to at least one of the learning models, and output signals (e.g., control signals, alerts, and/or display signals) are generated corresponding to the estimated current tool wear state.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND

The present disclosure relates generally to automatic wear detection for work machine tools, such as furrow-generating tools for row crop planters. The present disclosure more particularly relates to systems and methods utilizing learning models trained on furrow images in combination with an array of detected operating conditions to estimate tool wear, preferably during current operations.

Row crop planters as known in the art have used tools such as double disc openers which typically cut through residue and provide a V-shaped trench in which to place the seed. However, as the diameter of the tool becomes smaller with wear, the depth of seed placement can decrease to something less than the target depth. If the sharp edge wears off, the tool will not cut through residue as well and a condition known as “hair pinning” may occur at the bottom of the trench. In such conditions, residue may be pushed into the furrow and negatively impact or even prevent the seed-to-soil contact required for germination and desired yield potential.

One conventional way to understand if tools are worn and need replacing is to use a tape measure to measure the diameter of the blade and replace them if they are below a certain threshold. Such a procedure is sufficient during an off-season inspection, but it is challenging to get an accurate measurement with the gauge wheel installed. In addition, removal of the gauge wheel is quite time consuming, and therefore undesirable to manually perform such an inspection during the planting season.

### BRIEF SUMMARY

As disclosed herein, various inputs relating to furrow characteristics and operating conditions are collected during planting operations and used to train learning models for estimating tool wear. Systems and methods as disclosed herein may be implemented using for example a first input including a video feed of the trench and a second input associated with a laser or equivalent to measure the trench depth. Computer vision and machine learning techniques may be used to identify crop residue, dust, and the like that could be blocking the view of the camera. The combination of inputs, further optionally in view of additional inputs such as relating to ground conditions, machine operations, and the like may be utilized to automatically detect the effects of worn tools, such as furrow opening tools, and notify the operator when it is time to replace them, without relying on manual or otherwise direct physical inspection of the furrow opening tools themselves.

For example, a machine learning model may be trained on images from a furrow vision camera to identify the conditions of a W-shaped trench and hair pinning of residue in the trench bottom. The W-shaped trench is a clear indicator of tool wear. Shallow trench depth can be caused by disk wear, but it can also be caused by insufficient down force for the ground conditions, or row unit bounce in high speeds with rough ground conditions. The amount of “hair pinning” is also potentially affected by the softness of the soil, the toughness of the residue, and other conditions potentially in addition to the wear state of the tools, and accordingly may preferably be accounted for during model training and real time estimation.

In a first exemplary embodiment, a computer-implemented method is disclosed for real-time estimation of wear for a furrow-generating tool associated with an agricultural work machine. In a model development stage, input data sets are generated based on signals received from a plurality of sensors associated with each of respective agricultural work machines and planting operations, wherein the input data sets correspond at least to values for one or more furrow characteristics and one or more operating conditions, and one or more learning models are trained correlating the input data sets with tool wear. In a current operation stage for a first agricultural work machine, values are determined for one or more furrow characteristics and one or more operating conditions based on received input signals from a plurality of sensors associated with the first agricultural work machine, a current tool wear state is estimated based on the determined values and by reference to at least one of the one or more learning models, and an output signal is generated corresponding to the estimated current tool wear state.

In one exemplary aspect according to the above-referenced method embodiment, the values for one or more furrow characteristics may be determined based on received input signals from a first sensor comprising an imaging device having a field of view including a furrow generated by the tool during an operation, and from a second sensor configured to receive reflected signals representing a depth of the corresponding furrow.

In another exemplary aspect according to the above-referenced method embodiment, the values for one or more operating conditions may be determined based on input signals representing at least an advance speed for the agricultural work machine and a down force applied to the tool during the operation.

In another exemplary aspect according to the above-referenced method embodiment, the values for one or more operating conditions may be determined based on input signals representing at least one of a soil condition and a residue condition associated with the furrow generated by the tool during the operation.

In another exemplary aspect according to the above-referenced method embodiment, the generated output signal may comprise a control signal to an actuator for controlling a down force applied to the tool during operation, based on a determined target value for the down force at least partially in view of the estimated current tool wear state.

In another exemplary aspect according to the above-referenced method embodiment, the generated output signal may comprise a control signal to an actuator for controlling an advance speed of the agricultural work machine during operation, based on a determined target value for the advance speed at least partially in view of the estimated current tool wear state.

In another exemplary aspect according to the above-referenced method embodiment, a remaining life of the tool may be predicted based on the estimated current tool wear state, wherein the generated output signal comprises a display signal to a user interface for generating at least one display element relating to the remaining life of the tool.

In another exemplary aspect according to the above-referenced method embodiment, the remaining life of the tool may be based at least in part on a predicted wear rate corresponding to current operating conditions.

In another exemplary aspect according to the above-referenced method embodiment, the at least one display element may comprise an intervention alert relating to the remaining life of the tool.

In another embodiment as disclosed herein, a system for real-time estimation of wear for a furrow-generating tool associated with an agricultural work machine may include data storage having stored thereon one or more learning models correlating historical input data sets with tool wear, wherein the input data sets are associated with each of respective agricultural work machines and planting operations, and correspond at least to values for one or more furrow characteristics and one or more operating conditions, and one or more processors functionally linked to a plurality of sensors associated with a first agricultural machine and configured to, in association with a current operation of the first agricultural work machine to direct the performance of steps according to the above-referenced method embodiment and optionally one or more of the aspects thereof.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a perspective view representing an exemplary embodiment of a work machine, and more particularly a plurality of row units mounted to a rear portion thereof, according to the present disclosure.

FIG. 2 is a side view representing an exemplary row unit according to the present disclosure.

FIG. 3 is a block diagram representing an embodiment of a system according to the present disclosure.

FIG. 4 is a flowchart representing an embodiment of a method according to the present disclosure.

### DETAILED DESCRIPTION OF THE INVENTION

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements unless the context clearly indicates otherwise.

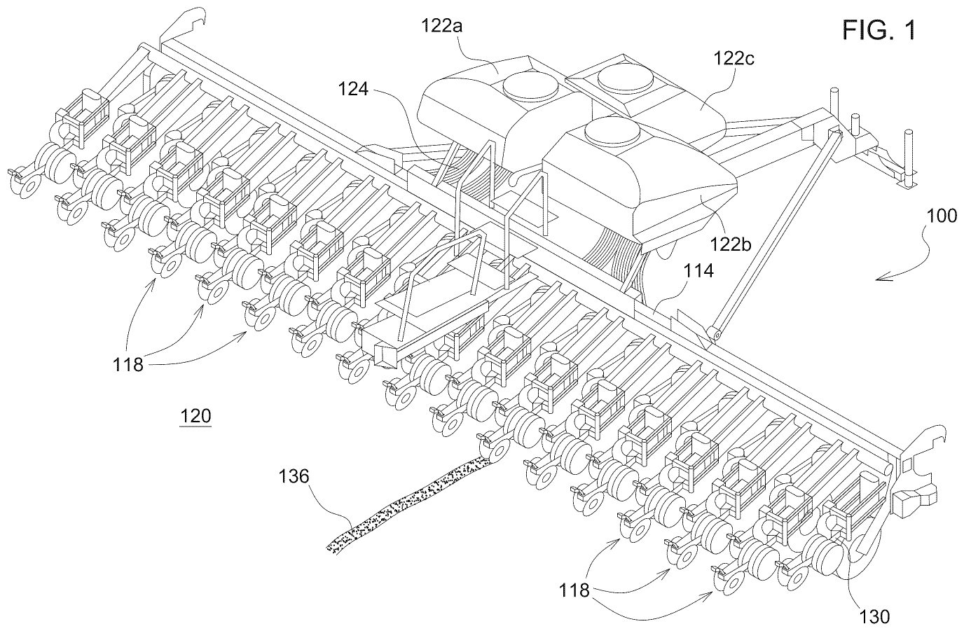

Referring now to the drawings, FIG. 1 illustrates a row crop planter as an embodiment of a work machine 100. The illustrated embodiment of FIG. 1 is exemplary and not intended as being limiting on the scope of an invention as described herein, unless otherwise specifically noted.

The illustrated work machine 100 includes a main frame 114. A plurality of individual row units 118 are coupled (e.g., mounted) on a rear portion of the main frame 114 such that the row units 118 are pulled over or across a layer of soil 120. Alternatively, the row units 118 may be positioned forward of the frame 114 and are pushed over or across the soil layer 120, or the machine may have a combination of push and pull row units 118. Seed sources, such as storage tanks 112a, 122b, 122c, are coupled to the main frame 114 and hold seed that is delivered, e.g., pneumatically or in any other suitable manner, to a mini-hopper (not shown) associated with each row unit 118. The storage tanks 122a, 122b, 122c are coupled to the mini-hoppers by way of conduits 126, such as hoses, and a pressurized delivery apparatus (not shown). Each storage tank 122a, 122b, 122c contains the same or different varieties of seed to be planted in the soil 120. Each row unit 118 is connected to a conduit 126 such that each row unit 118 is coupled to a storage tank 122a, 122b, 122c to receive seed. As illustrated by way of example only in FIG. 1, each row unit 118 further includes its own sub-frame 130, to which various components (e.g., a furrow opener, a furrow closer, etc.) are mounted.

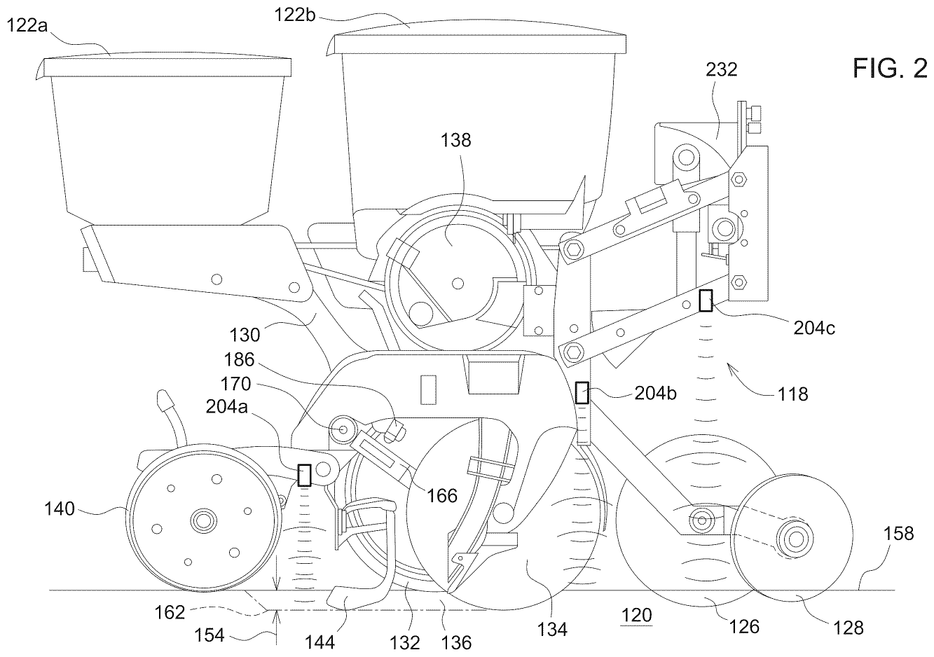

FIG. 2 illustrates another example of a row unit 118 that may be used in place of any one of the row units 118 in FIG. 1. The row unit 118 as illustrated in FIG. 2 includes hoppers 122a, 122b, which hold chemical and seed, respectively (as opposed to the row unit 118 receiving seed from bulk storage as in the construction illustrated in FIG. 1). The hoppers 122a, 122b are coupled to a row unit sub-frame 130.

Each row unit 118 also includes a gauge wheel or wheels 132 coupled to the row unit sub-frame 130. The gauge wheel 132 contacts and rolls along the soil 120, and a work tool 134 (e.g., an opening wheel or blade or other structure having a stationary or rotating surface that contacts and moves soil away to form a furrow) is coupled to the row unit sub-frame 130 for forming a furrow 136 (illustrated schematically) in the soil 120.

A seed metering device 138 coupled to the row unit sub-frame 130 receives seeds from the hopper 122b and meters and dispenses the seeds into the furrow 136. A furrow closer 140 (e.g., a closing and packing wheel or wheels or other structure having a stationary or rotating surface that contacts and presses soil 120) coupled to the row unit sub-frame 130 pushes soil around the seeds to close the furrow 136. Each row unit 118 may also include a seed firmer 144 (e.g. an angled arm as illustrated in FIG. 2, a press wheel coupled to a press wheel arm, or other structure that firms a seed) coupled to the row unit sub-frame 130 that firms each seed and pushes it into the open furrow 136 to ensure good seed to soil contact before the furrow 136 is closed. FIG. 2 also illustrates an optional coulter wheel 122 and row cleaner 123 forward of the furrow opener 134.

The row unit 118 also includes a downforce control unit 232 coupled to the main frame 114 and to the row unit sub-frame 130. The downforce control unit 232 includes springs, pneumatics, hydraulics, linkages, and/or other structures such that when activated, the downforce control unit 232 pushes the row unit sub-frame 130 of the row unit 118 and consequently the furrow opener 134 into the soil 120 to dig the furrow 136. The gauge wheels 132, however, continue to ride along the top surface 158 of the soil 120. A depth 154 of the furrow 136 is measured from a top surface 158 of the soil 120 to the bottom 162 of the furrow 136, along a direction that is perpendicular to the top surface 158 (assuming a flat, non-inclined top surface), and therefore depends on a position of the gauge wheels 132 relative to the furrow opener 134. In some constructions, the depth 154 is equivalent to a distance between a bottom of the gauge wheel or wheels 132 and a bottom of the furrow opener 134.

With continued reference to FIG. 2, the gauge wheel(s) 132 are coupled to the sub-frame 130 with respective arms 166 and respective pivots 170. Stops 186 are also provided for each gauge wheel arm 166 to limit the upward rotation of each gauge wheel arm 166. The stops 186 are adjustable to a desired position to set the depth 154 of the furrow 136. The position of the stops 186 may be manually adjusted or a remote adjustment assembly as known in the art may be included. However, during operating conditions the gauge wheel arms 166 may not always be contacting the stops 186, and thus the actual depth 154 may not be determined solely by knowing the position of the stops 186. Additionally, the furrow opener 134 can wear during use, altering the actual depth 154. Thus, relying on the stops 186 alone is not sufficient to determine the actual depth 154 of the furrow 136 at any given time.

Each row unit 118 also includes at least one furrow characteristic sensor 204A configured with a field of view directed toward a surface of the ground, and more particularly operable to at least collect data (e.g., capture images) associated with the furrow 136. The furrow characteristic sensor 204A in the illustrated embodiment is supported directly or indirectly by the sub-frame 130. An image-capturing furrow characteristic sensor 204A may for example include may include a video camera configured to record an original image stream and transmit corresponding data to the controller 212. In the alternative or in addition, the furrow characteristic sensor 204A may include one or more of an infrared camera, a stereoscopic camera, a PMD camera, high resolution light detection and ranging (LiDAR) scanners, radar detectors, laser scanners, and the like within the scope of the present disclosure. Corresponding outputs associated with a furrow characteristic sensor 204A may accordingly relate to images of a perception field (e.g., field of view), point clouds, reflectance/time-of flight data, etc. One of skill in the art may further appreciate that, e.g., image data processing functions may be performed discretely at a given furrow characteristic sensor 204A if properly configured, but also or otherwise may generally include at least some image data processing by the controller 212 or other downstream data processor. For example, data from any one or more furrow characteristic sensors 204A may be provided for three-dimensional point cloud generation, image segmentation, object delineation and classification, and the like, using image data processing tools as are known in the art in combination with the objectives disclosed.

An image-capturing furrow characteristic sensor 204A may operate alone or with one or more additional furrow characteristic sensors 204A over the furrow 136 to view into and directly detect the furrow 136 (e.g., at the furrow bottom 162) and/or generate depth signals corresponding to an actual direct measurement of a depth 154 of the furrow 136. For example, a single furrow characteristic sensor 204A, multiple furrow characteristic sensors 204A in a single device housing, multiple housings including respective furrow characteristic sensors 204A, or the like may be configured to capture first data comprising images including the furrow 136, and further to receive second data comprising signals representing characteristics (or for generating point clouds representing characteristics) such as for example the depth 154 of the furrow 136.

One of skill in the art may appreciate that knowledge of the position of the gauge wheels 132 can yield a value corresponding to furrow depth 154. However, the furrow characteristic sensor(s) 204A of FIG. 2 are adapted to detect furrow depth 154 directly, without reliance on detection of gauge wheels 132, gauge wheel arms 166, or other assumed dimensional values. By divorcing the furrow characteristic sensor(s) 204A from measurement of the gauge wheels 132 and gauge wheel arms 166, complications arising from the variation among independent movements of the gauge wheels 132 and gauge wheel arms 166 of a given row unit 118 may preferably be avoided.

With reference to FIG. 2, an exemplary furrow characteristic sensor 204A as described herein may be positioned rearward of an effective point of the tool 134 (i.e., the longitudinal location at which the tool 134 opens the furrow 136) and forward of an effective point of the closer 140 (i.e., the longitudinal location at which the closer 140 closes the furrow 136) so as to be located above the furrow 136 and to overlap the furrow 136 in plan view. In some constructions, the furrow characteristic sensor 204A may be centered over the width of the furrow 136 in a direction perpendicular to the longitudinal direction (i.e., the furrow width direction extends into the page when viewing FIG. 2). As illustrated, the furrow characteristic sensor 204A is also positioned rearward of a point of contact of the gauge wheel(s) 132 with the soil 120.

In an embodiment, an exemplary furrow characteristic sensor 204A may be operable to emit (i.e., from one or more emitters) sound or electromagnetic radiation into the furrow 136 and to detect (i.e., from one or more receivers) a reflection of the sound or electromagnetic radiation from the furrow in order to sense the furrow 136. The furrow characteristic sensor 204A thus forms a furrow depth sensor, distinct from or integrated with an image-capturing furrow characteristic sensor 204A as previously noted. In other constructions, the furrow characteristic sensor 204A can be a passive sensor that senses the furrow 136 to measure furrow depth by detection of the furrow 136 only, without the sensor 204A emitting any sound or electromagnetic radiation.

In some embodiments, an exemplary furrow characteristic sensor 204A may include an optical sensor, and may include a photodiode operable to detect light, either within or outside of the visible spectrum.

In some embodiments, an exemplary furrow characteristic sensor 204A may include an infrared sensor, which may be referred to as an IR camera. Such an IR camera can detect the depth 154 of the furrow 136, and may additionally detect the temperature of the furrow 136. The dispensed seeds may have a discernable temperature difference from the soil of the furrow 136, thus enabling seed identification and also seed position data to be collected from the furrow characteristic sensor 204A.

In some embodiments, an exemplary furrow characteristic sensor 204A comprises an ultrasonic sensor, including an emitter operable to emit ultrasound waves and a receiver operable to detect reflected ultrasound waves that reflect off the furrow 136. In some constructions, an exemplary furrow characteristic sensor 204A comprises a radar transmitter and receiver.

In some embodiments, an exemplary furrow characteristic sensor 204A comprises a laser and a photodetector and may be referred to as a LiDAR or LADAR sensor. With appropriate placement and configuration, the furrow characteristic sensor 204A can detect a shape of the furrow 136, rather than just the maximum or central depth thereof. Thus, furrow shape data (i.e., 2-D or 3-D) can also be collected by the furrow characteristic sensor 204A.

As previously noted, more than one furrow characteristic sensor 204A may be positioned above the furrow 136. Multiple sensors can be of the same type or a combination of different types. Multiple sensors can be positioned at the same longitudinal position on the row unit 118 or at spaced positions along the longitudinal direction. The illustrated furrow characteristic sensor 204A is supported on a mounting arm that supports the furrow closer 140. In other constructions, the furrow characteristic sensor 204A is supported by another structure of the row unit 118, e.g., a dedicated sensor arm or bracket, direct connection to the sub-frame 130, etc.

In various embodiments, the row unit 118 includes only one or more furrow characteristic sensors 204A positioned directly over the furrow 136. FIG. 2 also illustrates an optional complement of one or more additional furrow characteristic sensors 204B, 204C positioned outside the furrow 136 (e.g., adjacent, but ahead of the furrow 136). These additional furrow characteristic sensor(s) 204B, 204C are also supported directly or indirectly by the sub-frame 130, and can utilize any of the type(s) of sensing technology described above for the furrow-viewing sensor 204A. Although the additional sensor(s) 204B, 204C cannot sense the furrow 136 directly, they can still operate as ground viewing sensors used in providing respective output signals related to furrow characteristics. For example, when there is significant crop residue on the soil 120, the additional sensor(s) 204B, 204C ahead of the furrow can detect how deep the tool 134 is into the soil 120. This is done by detecting reflected electromagnetic radiation off the top soil surface 158, in combination with the known positional relationship between the tool 134 and the sensor(s) 204B, 204C, since both are fixed with respect to the sub-frame 130. Measurement data collected this way can be used together with the primary over-the-furrow sensor(s) 204A for redundancy, complementation, or compensation. The additional sensor(s) 204B, 204C can be positioned at a variety of locations on the row unit 118, at the same or different longitudinal positions. As illustrated, a first of the additional sensors 204B is supported on a forward end of the sub-frame 130, for example adjacent a linkage (parallel four-bar linkage) that couples the sub-frame 130 to the main frame 114. A second additional sensor 204C is illustrated as being supported on one of the links of the linkage, although other positions are optional. The sensors 204A, 204B, 204C can be aimed to point straight down, such that the sound and/or electromagnetic radiation emitted makes a 90-degree angle with the top surface 158 of the soil 120 as shown. In other constructions, one or more of the sensors 204A, 204B, 204C is or are aimed to point predominantly downward toward the soil 120, at an angle other than 90 degrees.

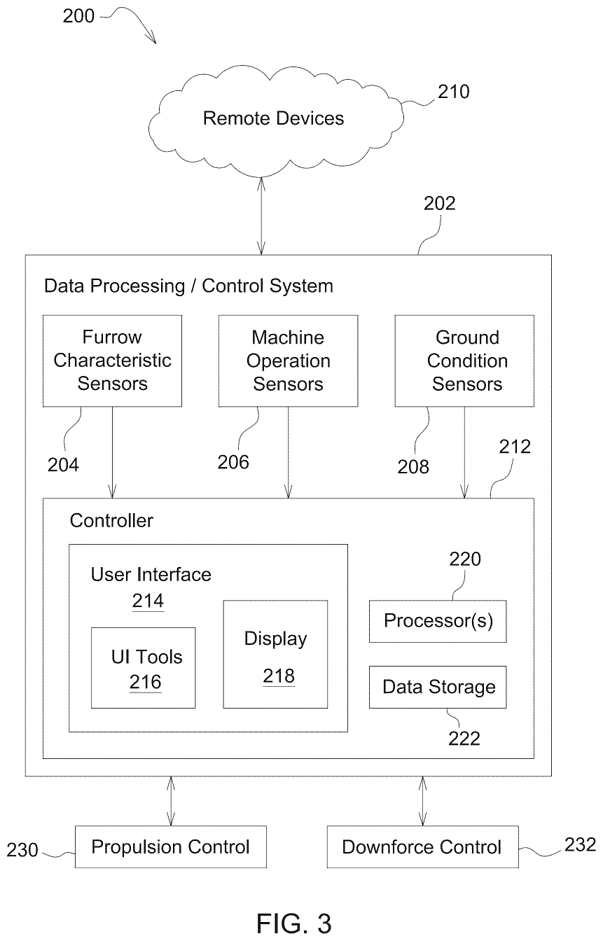

As illustrated in FIG. 3, an embodiment of a system 200 according to the present disclosure may include a data processing and control system 202 substantially onboard the work machine and functionally in communication with one or more remote computing devices 210 via a communications network. The remote computing devices 210 may include, for example, mobile computing devices associated with users/operators, server devices such as for example in a cloud computing context, onboard devices associated with other work machines, etc. Output signals from the furrow characteristic sensors 204A, 204B, 204C may be sent to a controller 212 within or otherwise defining the control system 202. The controller 212 may be positioned at various locations on the work machine 100. For example, in some constructions the controller 212 is positioned within the operator cab, and signals are sent by wire or wirelessly from the sensors 204A, 204B, 204C to the controller 212.

Additional sensors which may provide output signals to the controller 212 in the embodiment of FIG. 3 include machine operation sensors 206 and/or ground condition sensors 208.

Machine operation sensors 206 may for example include any sensors or alternative data sources configured to provide inputs to the controller 212 representing or otherwise corresponding to machine operating parameters such as for example advance speed, steering angle, work implement positions, engine load, draft load, wheel slip, applied machine downforce, downforce margin, and data about ride quality, or any other data relevant to the operation of a work machine.

Ground condition sensors 208 may for example include any sensors or alternative data sources configured to provide inputs to the controller representing or otherwise corresponding to ground conditions such as soil softness, soil moisture, capacitance, VNIR absorption, temperature, electrical conductivity, historical seed map information, and the like. In some embodiments, a ground condition sensor 208 may be or otherwise include one or more of the machine operation sensors 206. In some embodiments, values for one or more ground condition parameters may be indirectly estimated based on inputs from one or more machine operating sensors. In some embodiments, a ground condition sensor 208 may be or otherwise include one or more of the furrow characteristic sensors 204A, 204B, 204C.

The controller 212 includes or may be associated with one or more processors 220, data storage 222, and a user interface 214 which may include or otherwise associated with user interface tools 216 for input/output functions and a display 218. The user interface 214 may take the form of a control panel in an operator cab, or part of a user interface for a remote device 210. User interface tools 216 may include a keyboard, joystick, touchscreen, mobile device, or other equivalent devices, such that for example a human operator may input instructions to the controller 212. Data transmission between, for example, a work machine control system 202 and a remote user interface may take the form of a wireless communications system and associated components as are conventionally known in the art. In certain embodiments, a remote user interface and control systems for respective work machines may be further coordinated or otherwise interact with a remote server or other computing device 210 for the performance of operations in a system 200 as disclosed herein.

It is understood that the controller 212 described herein may be a single controller having the described functionality, or it may include multiple controllers wherein the described functionality is distributed among the multiple controllers. Some or all of the controllers may be located at a location other than the work machine 100 and be connected wirelessly.

Various operations, steps or algorithms as described in connection with the controller 212 can be embodied directly in hardware, in a computer program product such as a software module executed by the processor 220, or in a combination of the two. The computer program product can reside in RAM memory, flash memory, ROM memory, EPROM memory, EEPROM memory, registers, hard disk, a removable disk, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

According to one aspect of the present disclosure, the controller 212 is configured to receive signals from one or more sensors 204, 206, 208 and to produce and transmit one or more output signals in response to or based in part on the input signals. The controller 212 can also be in communication with one or more actuators, for example associated with a propulsion control unit 230 and/or a down force control unit 232, wherein the output signals may for example be control signals that control the advance speed and/or down force applied on the work tools. The control units 230, 232 may be independent or otherwise integrated together or as part of a machine control system 200 in various manners as known in the art. The control signals to the propulsion control unit 230 may for example comprise a propulsion control signal or data message that controls a throttle setting, a fuel flow, a fuel injection system, vehicular speed or vehicular acceleration. Further, where the work machine 100 may be propelled by an electric drive or electric motor, the propulsion control signal may control or modulate electrical energy, electrical current, electrical voltage provided to an electric drive or motor.

The lines that interconnect the components of the system 200 may comprise logical communication paths, physical communication paths, or both. Logical communication paths may comprise communications or links between software modules, instructions, or data, whereas physical communication paths may comprise transmission lines, data buses, or communication channels, to name non-limiting examples.

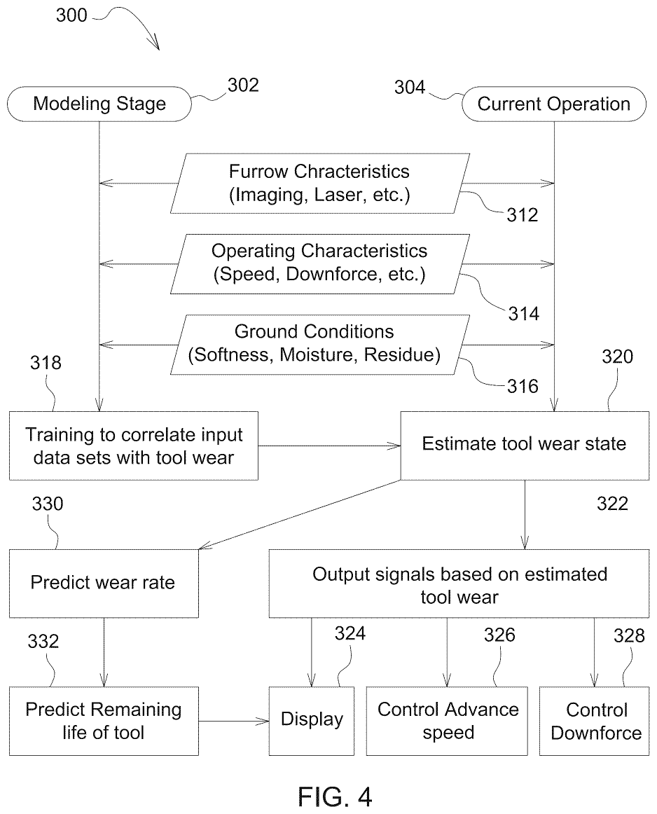

Referring next to FIG. 4, the depicted flowchart represents an exemplary embodiment of a method 300, for example for automatic estimation of wear for a furrow-generating tool in association with planting operations in an agricultural work area. Various embodiments of the method 300 described herein may preferably involve the detection of tool wear, maintenance issues, and/or ground conditions in the work area and enable intervention with respect thereto before they negatively impact planting performance.

The discussion below regarding the method 300 may for illustrative purposes reference an exemplary work machine 100, row unit 118, and system 200 according to FIGS. 1-3, but the scope of a method according to the present disclosure is not so limited unless otherwise specifically noted herein. While the illustrated embodiment may include a specific arrangement of steps, inputs, outputs, and the like, it may be understood that certain steps may be combined, performed in a different order, or even omitted altogether in other embodiments within the scope of the present disclosure, unless otherwise specifically noted herein.

In an embodiment, the method 300 includes a current operation stage 304 wherein a tool wear state is estimated based on captured images of a furrow produced during operation, and typically further in view of supplemental data. In various embodiments, as illustrated in FIG. 4, for example, the method 300 further includes a model development stage 302, wherein the tool wear state is estimated during the current operation stage based in part on learning models (the term as used herein typically including models and algorithms) that are trained over time to correlate input data sets with observed outcomes such as tool wear.

The input data sets in each stage may include input data 312 corresponding to furrow characteristics (e.g., provided via furrow characteristic sensors 204 as described above), input data 314 corresponding to machine operating characteristics (e.g., provided via machine operation sensors 206 as described above), and/or input data 316 corresponding to ground conditions (e.g., provided via ground condition sensors 208 as described above). The inputs may be understood as representing actual and substantially real-time values, wherein “substantially real-time” may typically indicate the values are as close to real-time as possible while accounting for some inherent delays in sensing, converting, transmitting, or otherwise indicating to the respective values to the controller during the work machine operation.

It may be understood that steps of the current operation stage 304 overlap in various embodiments with steps associated with a corresponding model development stage 302, as for example inputs provided in steps 312, 314, 316 and outputs in various subsequent steps as described below may be provided for iterative development and potential improvement of the learning models, prior to or otherwise while in the context of the current operation stage 304.

For embodiments of the method 300 including a model development stage 302, it may be understood that input data sets may be collected, aggregated, processed, and/or the like based on signals received from the respective sensors or equivalent data sources associated with each of various agricultural work machines and according to various planting operations over time. It may be appreciated that input data such as images may include features, for example corresponding to characteristics of the furrow, that may in some cases be extracted and sufficiently identified without requiring cross reference to other inputs, but the presence of multiple types of inputs such as measured furrow depth, soil conditions, and the like, may facilitate or even enhance the model training process over time.

In step 318, the learning models are trained to correlate the input data sets with tool wear. In an embodiment, the model generation stage 302 may include validation and storage of the models, having been sufficiently developed over time using “test” input data sets and corresponding observed outcomes (e.g., tool wear states), for example including feedback from “current” data sets, such that they may be retrieved and utilized during subsequent operations for tool wear state estimation and/or predictions of remaining tool life based on subsequent operations and corresponding data sets.

In some embodiments, the models may include neural network-based models having variable governing parameters which are optimized during training to better simulate (or approximate in a particular simulation) observed real-life results corresponding to an input data set. Such parameters may initially be set (e.g., user-specified) before training. Tuning of the hyperparameters, or in other words optimizing the values therefor, may follow during training to obtain a set of values for the parameters corresponding to an accurate input-output mapping of the neural network for the training data set. In various embodiments, tuning of parameters may be performed automatically during or between training iterations, manually based on user selection via a user interface, or combinations thereof. In some embodiments the parameters are not initially user-specified but instead predetermined formulaically or otherwise according to a “best guess” distribution of possible simulation parameters, and in some embodiments may initially be unknown and merely derived during training. The parameters may for example determine aspects of the neural network structure and/or training parameters, such as the number of hidden neuron layers, number and/or definition of training steps, learning rates, batch size, and the like.

Turning next to a current operation stage 304, the method includes collecting “current” data sets based on determined values from inputs 312, 314, 316 and further estimating a current tool wear state based on the determined values and by reference to at least one of the trained learning models. In an embodiment, for example, a learning model has trained on images over time to identify indications of tool wear in the context of a W-shaped furrow and hair pinning of residue in the bottom of the furrow. However, a shallow furrow depth is not exclusively correlative with tool wear, and may also be caused by mismatches between current work machine operating conditions and the current ground conditions in the work area. For example, a current applied down force may be insufficient for the ground conditions, the row unit may be bouncing due to higher advance speeds than are recommended for the ground conditions, or the like. Accordingly, an array of inputs may be accounted for by the models to determine the current tool wear state, or to validate the current tool wear state as initially determined from the images (e.g., via a computer vision system and by reference to the image-trained models), etc., by further considering all of the other contributing factors to the observed furrow characteristics and in a more holistic manner than is otherwise possible using the images alone.

The method may continue in step 322 by generating output signals corresponding to the estimated current tool wear state. In some embodiments, output signals may be continuously provided to correspond with the estimated current tool wear state, such as for example where the tool state is to be persistently displayed (step 324). In other embodiments, output signals may be periodically provided in an event-based manner, for example where an intervention event is determined based on the estimated current tool wear state, or other values derived at least in part there from.

In an embodiment, the output signals may include display signals representing the estimated current tool wear, or an alert corresponding to the estimated current tool wear, among other possible display elements which may be provided in step 324 to a display unit for display to an operator or other authorized user.

In an embodiment, the method 300 may include a step 330 of predicting a wear rate for the tool, based for example on historical information regarding wear states of the tool over time, wear rates for equivalent tools, usage data, ground conditions, and the like. A further exemplary step 332 may include predicting a remaining life for the tool, based for example on the predicted wear rate, the current wear state, and historical information regarding an expected life span for equivalent tools.

The predicted remaining life of the tool may further be provided as a display element to a display unit in step 324. In association with a predicted remaining life, an intervention alert may be generated as a display element, for example where a change in tools is recommended, based on threshold value violations, parameters associated with planned operations, or the like.

In an embodiment, the output signals may include a control signal to an actuator, for example as or as part of a propulsion control unit 230, for controlling an advance speed of the agricultural work machine 100 during operation, based on a determined target value for the advance speed at least partially in view of the estimated current tool wear state.

In an embodiment, the output signals may include a control signal 328 to an actuator, for example as or as part of a down force control unit 232, for controlling a down force applied to the tool during operation, based on a determined target value for the down force at least partially in view of the estimated current tool wear state.

In some embodiments, determination of whether to control down force and/or advance speed may include reference to a soil map (e.g., stored within data storage 222 such as a memory of the controller 212, and/or created manually). For example, the controller 212 may determine what settings (speed and down force) are expected to achieve the greatest furrow depth consistency for a set of observed furrow characteristics, as well as different locations and soil conditions in a field. The controller 212 may then determine that variance from those settings in a current operation, further in view of current ground conditions for example, is attributable to tool wear, and determine whether a change in down force and/or advance speed is warranted and/or desirable to correct for the variance. For example, in some embodiments either down force or advance speed may be a primary control parameter to correct for variance attributed to tool wear, based for example on a soil type (e.g., sandy soil as opposed to clay soil, having different concerns regarding compaction), soil moisture, etc.

Thus, although there have been described particular embodiments of the present invention of a new and useful invention, is not intended that such references be construed as limitations upon the scope of this invention except as set forth in the following claims.

What is claimed is:

1. A computer-implemented method for automatic estimation of wear for a furrow-generating tool associated with an agricultural work machine, the method comprising:
in a model development stage:
generating input data sets based on signals received from a plurality of sensors associated with each of respective agricultural work machines and planting operations, wherein the input data sets correspond at least to values for one or more furrow characteristics and one or more operating conditions;
training one or more learning models correlating the input data sets with tool wear; and
in a current operation stage for a first agricultural work machine:
determining values for one or more furrow characteristics and one or more operating conditions based on received input signals from a plurality of sensors associated with the first agricultural work machine;
estimating a current tool wear state based on the determined values and by reference to at least one of the one or more learning models; and
generating an output signal corresponding to the estimated current tool wear state.

2. The method of claim 1, wherein the values for one or more furrow characteristics are determined based on received input signals from a first sensor comprising an imaging device having a field of view including a furrow generated by the tool during an operation, and from a second sensor configured to receive reflected signals representing a depth of the corresponding furrow.

3. The method of claim 2, wherein the values for one or more operating conditions are determined based on input signals representing at least an advance speed for the agricultural work machine and a down force applied to the tool during the operation.

4. The method of claim 2, wherein the values for one or more operating conditions are determined based on input signals representing at least one of a soil condition and a residue condition associated with the furrow generated by the tool during the operation.

5. The method of claim 1, wherein the generated output signal comprises a control signal to an actuator for controlling a down force applied to the tool during operation, based on a determined target value for the down force at least partially in view of the estimated current tool wear state.

6. The method of claim 1, wherein the generated output signal comprises a control signal to an actuator for controlling an advance speed of the agricultural work machine during operation, based on a determined target value for the advance speed at least partially in view of the estimated current tool wear state.

7. The method of claim 1, comprising predicting a remaining life of the tool based on the estimated current tool wear state, wherein the generated output signal comprises a display signal to a user interface for generating at least one display element relating to the remaining life of the tool.

8. The method of claim 7, wherein the remaining life of the tool is based at least in part on a predicted wear rate corresponding to current operating conditions.

9. The method of claim 7, wherein the at least one display element comprises an intervention alert relating to the remaining life of the tool.

10. A system for automatic estimation of wear for a furrow-generating tool associated with an agricultural work machine, the system comprising:
data storage having stored thereon one or more learning models correlating historical input data sets with tool wear, wherein the input data sets are associated with each of respective agricultural work machines and planting operations, and correspond at least to values for one or more furrow characteristics and one or more operating conditions;
one or more processors functionally linked to a plurality of sensors associated with a first agricultural machine and configured to, in association with a current operation of the first agricultural work machine:
determine values for one or more furrow characteristics and one or more operating conditions based on received input signals from the plurality of sensors;
estimate a current tool wear state based on the determined values and by reference to at least one of the one or more learning models; and
generate an output signal corresponding to the estimated current tool wear state.

11. The system of claim 10, wherein the values for one or more furrow characteristics are determined based on received input signals from a first sensor comprising an imaging device having a field of view including a furrow generated by the tool during an operation, and from a second sensor configured to receive reflected signals representing a depth of the corresponding furrow.

12. The system of claim 11, wherein the values for one or more operating conditions are determined based on input signals representing at least an advance speed for the agricultural work machine and a down force applied to the tool during the operation.

13. The system of claim 11, wherein the values for one or more operating conditions are determined based on input signals representing at least one of a soil condition and a residue condition associated with the furrow generated by the tool during the operation.

14. The system of claim 10, wherein the generated output signal comprises a control signal to an actuator for controlling a down force applied to the tool during operation, based on a determined target value for the down force at least partially in view of the estimated current tool wear state.

15. The system of claim 10, wherein the generated output signal comprises a control signal to an actuator for controlling an advance speed of the agricultural work machine during operation, based on a determined target value for the advance speed at least partially in view of the estimated current tool wear state.

16. The system of claim 10, wherein the one or more processors are configured to predict a remaining life of the tool based on the estimated current tool wear state, wherein the generated output signal comprises a display signal to a user interface for generating at least one display element relating to the remaining life of the tool.

17. The system of claim 16, wherein the remaining life of the tool is based at least in part on a predicted wear rate corresponding to current operating conditions.

18. The system of claim 16, wherein the at least one display element comprises an intervention alert relating to the remaining life of the tool.
